(19) United States
(12) Patent Application Publication
(10) Pub. No.: US 2006/0213621 A1
(43) Pub. Date: Sep. 28, 2006

(54) Laminating unit

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 11/185,887

(22) Filed: Jul. 21, 2005

(30) Foreign Application Priority Data
Mar. 24, 2005 (DE) 20 2005 005 020.2

(51) Int. Cl. B32B 37/00

(52) U.S. Cl. 156/556; 156/538; 156/583.1

(57) ABSTRACT

A laminating unit for laminating sheet material to at least one film has a housing that comprises a front side and a back side. A feedthrough conduit extends between the front and back sides and has an insertion opening for the introduction of sheet material and film(s) and an exit opening for ejection of the laminated combination of sheet material and films(s). A laminating device for laminating the sheet material and for transporting the combination of sheet material and film(s) to the exit opening during lamination is provided in the housing. The insertion opening is located on the back side of the housing and the exit opening on the front side.

### CROSS-REFERENCE TO RELATED APPLICATIONS AND CLAIM TO PRIORITY

This application is based upon utility model application number 20 2005 005 020.2, filed Mar. 24, 2005 in the Federal Republic of Germany, the disclosure of which is incorporated herein by reference and to which priority is claimed.

### FIELD OF THE INVENTION

The invention concerns a laminating unit for laminating sheet material to at least one film, having a housing that comprises a front side and a back side and a feedthrough conduit, extending between the front and back sides, that has an insertion opening for the introduction of sheet material and film(s) and an exit opening for ejection of the laminated sheet material, a laminating device for laminating the sheet material and for transporting the combination of sheet material and film(s) during lamination from the insertion opening to the exit opening being provided in the housing.

### BACKGROUND OF THE INVENTION

Laminating units are used in offices to encapsulate documents—for example brochures, legal documents, identification cards, etc.—between two transparent plastic films in order to protect them from soiling and damage. For the laminating operation, the sheet material can be placed between two loose films. Instead, however, the two films can also be present in the form of a laminating pouch, in which the two laminating films are heat-sealed to one another on two or three side edges. The sheet material to be laminated can be placed into the laminating pouch. The laminating films are transparent, so that the sheet material remains easily visible and readable. They retain that transparency even after heat-sealing. The laminating films are usually embodied, for that purpose, as so-called composite films (cf. Ullmanns Enzyklopädie der Technischen Chemie [Encyclopedia of industrial chemistry], 4th ed., Vol. 11, 1976, page 684, and Vol. 14, 1977, page 249).

The laminating units used for the laminating operation comprise a housing having a front side and a back side. As a rule, the width of the laminating units is greater than their depth. Extending between the front and back sides is a flat feedthrough conduit in which a laminating device is arranged. A laminating device of this kind substantially comprises two heated laminating rollers between which the combination of sheet material and films travels. In the process, the laminating rollers apply pressure and at the same time heat the films. The films thus adhesively bond to the sheet material being encapsulated and, at the edges, to one another. The laminating rollers also provide for the combination of sheet material and films to be transported through the laminating unit.

The feedthrough conduit begins on one side of the housing with a slot-shaped insertion opening through which the combination of sheet material and films can be introduced. Located on the other side is an exit opening through which the film-encapsulated sheet material emerges again from the housing. In known laminating units, the insertion opening is located on the front side, and the exit opening on the back side. A laminating unit of this kind is set up on a desk in such a way that the person sitting at the desk looks at the front side, and accordingly also loads the laminating unit from that side with sheet material to be laminated. The front side is usually provided with operating knobs and indicator lights.

To simplify insertion of the combination of sheet material and films, most laminating units have a sheet support onto which the sheet material to be laminated is laid together with the films, and can then be slid into the insertion opening. This results in a considerable space requirement. In addition, sufficient desk area must be present at the back side so that the encapsulated sheet material does not drop to the floor. The overall result of this is a considerable space requirement on the desk.

### SUMMARY OF THE INVENTION

It is the object of the invention to configure a laminating unit of the kind cited initially in such a way that it has a substantially smaller space requirement.

This object is achieved, according to the present invention, in that the insertion opening of the feedthrough conduit is located on the back side of the housing, and the exit opening on the front side, i.e. transport of the combination of sheet material and films occurs from the back side to the front side, and thus in the opposite way from laminating units of the existing art. Because of this reversal of the feedthrough direction, it is possible to position the laminating unit with its back side at the edge of a desktop, thereby freeing up a considerable amount of space. The sheet material emerging from the exit opening on the front side is then not subject to the risk of dropping to the floor, since it drops onto the desktop and can therefore be immediately picked up by the operator.

In an embodiment of the invention, provision is made for the feedthrough conduit to be inclined obliquely downward between the insertion opening and exit opening, preferably in such a way that the ejected sheet material does not drop down onto the desktop on which the laminating unit stands, but instead slides at an oblique angle onto the desktop.

In a further embodiment of the invention, provision is made for a sheet support, which constitutes a continuation of the underside of the feedthrough conduit, to be present in front of the insertion opening. The combination of sheet material and films can be placed onto the sheet support and then introduced in directed fashion into the insertion opening until the combination is grasped by the laminating rollers. The sheet support should be of flat configuration, in known fashion. It should preferably be upwardly foldable, at least with a segment that is spaced away from the insertion opening. It is more useful, however, if the entire sheet support is upwardly foldable. It is particularly advantageous if the sheet support or the upwardly foldable segment of the sheet support is foldable back onto the housing. In this case it is advisable to adapt the sheet support, or the upwardly foldable segment of the sheet support, to the conformation of the housing in such a way that the sheet support or the segment extends, in the folded-back state, substantially parallel to the housing, i.e. in practice constitutes a kind of cover for the housing.

### BRIEF DESCRIPTION OF THE DRAWINGS

The invention is illustrated in more detail, with reference to two exemplifying embodiments, in the drawings, in which:

FIG. 1 schematically depicts a first laminating unit in cross section, during introduction of the combination of sheet material and films; and

FIG. 2 shows the laminating unit according to FIG. 1 during ejection of the encapsulated sheet material;

FIG. 3 is a side view of a second laminating unit with the sheet support folded out; and

FIG. 4 is the side view as shown in FIG. 3, with the sheet support folded upward.

### DETAILED DESCRIPTION OF THE PREFERRED EMBODIMENT(S)

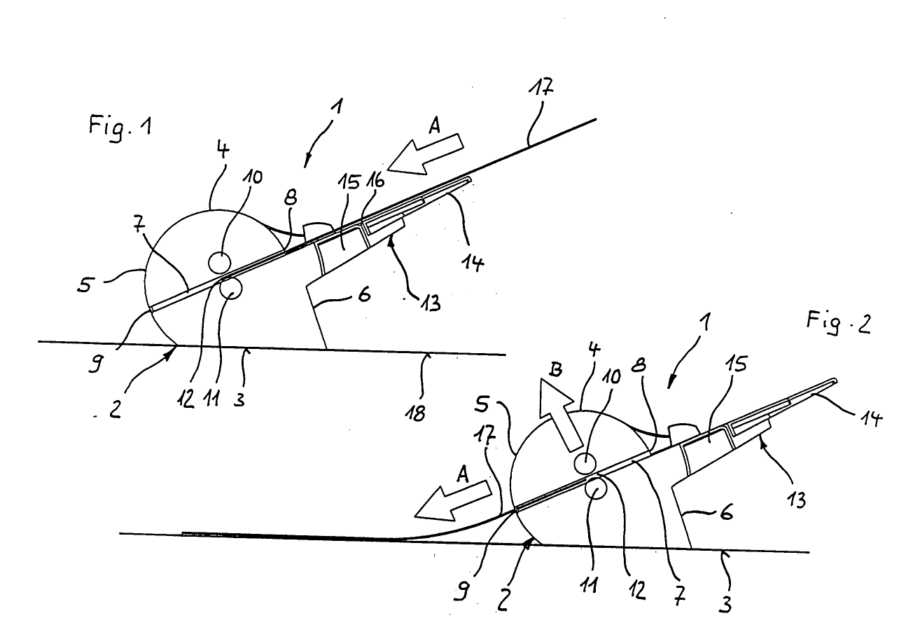

Laminating unit 1 depicted in FIGS. 1 and 2 has a housing 2 having a flat housing base 3 and a semi-cylindrical housing superstructure 4 that continues toward the rear in straight and oblique fashion into housing base 3. In the cross section shown, housing superstructure 4 extends perpendicular to the drawing plane and is delimited on both sides by flat sidewalls. Housing superstructure 4 forms a rounded front side 5 and a back side 6.

Extending through housing 2 from back side 6 to front side 5 is a downwardly directed feedthrough conduit 7, not very high and having a width such that DIN A4 sheet material can be fed through in landscape format. Feedthrough conduit 7 is delimited at one end by an insertion opening 8 at back side 6, and by an exit opening 9 at front side 5.

In feedthrough conduit 7 are two laminating rollers 10, 11 that are arranged one above another and form between them a laminating gap 12 that extends over the width of feedthrough conduit 7. Laminating rollers 10, 11 are heated, and are driven in the direction of the arrows.

Shaped onto back side 6 is a sheet support 13 whose upper side adjoins flush against the underside of feedthrough conduit 7 and is inclined in the same direction as feedthrough conduit 7 itself. A rear segment 14 is connected to a front segment 15 of sheet support 13 via a pivot joint 16 whose pivot axis extends perpendicular to the drawing plane. Rear segment 14 can be pivoted upward about pivot joint 16 toward housing superstructure 4, and laid over onto it.

For a laminating operation, a combination 17, made up of two films forming a laminating pouch and the sheet material to be placed into the laminating pouch and encapsulated, is placed onto sheet support 13 and then slid through insertion opening 8 into feedthrough conduit 7 until combination 17 is grasped by laminating rollers 10, 11. In laminating gap 12, combination 17 is compressed by laminating rollers 10, 11 and at the same time heated sufficiently that the laminating films adhesively bond to the sheet material and, at the edges, to one another. The direction of motion of combination 17 is indicated by arrows A. After passing through laminating gap 12, the heat-sealed combination 17 slides onto desktop 18 on which laminating unit 1 is standing (FIG. 2). Combination 17 can then be removed from laminating unit 1.

Arrow B indicates that upper laminating roller 8 can be raised in the direction of arrow B. This allows laminating gap 12 to be made larger. Any jam that may occur in laminating gap 12 can thereby be cleared.

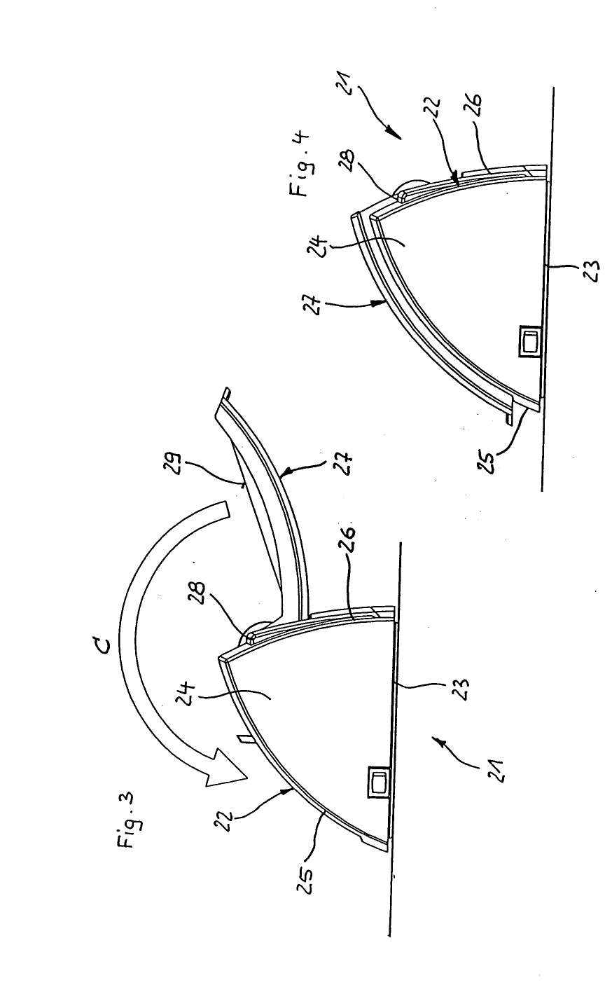

Laminating unit 21 depicted in FIGS. 3 and 4 has a housing 20, triangular in cross section, having a flat housing base 23 and a housing superstructure 24 that is constituted by an oblique and convexly curved front side 25 and an almost vertical but likewise convexly curved back side 26. A sheet support 27 is mounted on back side 26. Sheet support 27 is pivotable via a pivot joint 28 extending perpendicular to the drawing plane, in the direction of arrow C and back again, between the folded-out position depicted in FIG. 3 and the folded-over position depicted in FIG. 4.

In this laminating unit 21 as well, the feedthrough conduit (not depicted here in detail) extends from back side 26 to front side 25 at an inclination that corresponds to the inclination of support surface 29 of sheet support 27 and constitutes its extension.

Sheet support 27 has on the exterior the same convex curvature as front side 25. When folded over in the direction of arrow C, it comes to rest against front side 25 and matches its curvature. As a result, sheet support 27 takes up practically no space when laminating unit 21 is not in use.

I claim:

1. A laminating unit (1, 21) for laminating sheet material to at least one film, having a housing (2, 22) that comprises a front side (5, 25) and a back side (6, 26) and a feedthrough conduit (7), extending between the front and back sides (5, 6 or 25, 26), that has an insertion opening (8) for the introduction of sheet material and film(s) and an exit opening (9) for ejection of the laminated combination (17) of sheet material and films(s), a laminating device (10, 11) for laminating the sheet material and for transporting the combination (17) of sheet material and film(s) to the exit opening (9) during lamination being provided in the housing (2, 22),
wherein the insertion opening (8) is located on the back side (6, 26) of the housing (2, 22), and the exit opening (9) on the front side (5, 25).

2. The laminating unit as defined in claim 1, wherein the feedthrough conduit (7) is inclined obliquely downward between the insertion opening (8) and exit opening (9).

3. The laminating unit as defined in claim 1, wherein a sheet support (13, 27), which constitutes a continuation of the underside of the feedthrough conduit (7), is present in front of the insertion opening (8).

4. The laminating unit as defined in claim 3, wherein the sheet support (13, 27) is of flat configuration.

5. The laminating unit as defined in claim 3, wherein the sheet support (13, 27) is upwardly foldable, at least with a segment (14) that is spaced away from the insertion opening (8).

6. The laminating unit as defined in claim 5, wherein the sheet support (27), or the upwardly foldable segment (14) of the sheet support (13), is foldable back onto the housing (2, 22).

7. The laminating unit as defined in claim 6, wherein the sheet support (27), or the upwardly foldable segment of the sheet support, is adapted to the conformation of the housing (22) in such a way that the sheet support (27) or the segment extends, in the folded-back state, substantially parallel to the housing (22).
